(19) United States
(12) Patent Application Publication
(10) Pub. No.: US 2010/0096063 A1
(43) Pub. Date: Apr. 22, 2010

(54) Inspectability of composite items

(76) Inventor: S. Douglas Friddell, Issaquah, WA (US)

Correspondence Address: NovaTech IP Law, 1001 Ave. Pico, Suite C500, San Clemente, CA, 92673, US

(21) Appl. No.: 11/598,095

(22) Filed: Nov. 13, 2006

(51) Int. Cl. B32B 41/00

(52) U.S. Cl. 156/64; 156/378

(57) ABSTRACT

To improve imaging characteristics of a composite item fabricated from a layup of composite material, layers of sheet molding materials are interleaved with layers of organized fiber structure prepreg to generate the layup and the layup is positioned in a mold cavity of a matched die form. In addition, a first form of the matched die form is urged towards a second form of the matched die form to facilitate flow of a portion of the layup from an area of excess composite material in the mold cavity to an area of insufficient composite material in the mold cavity and the layup is cured to generate the composite item.

### FIELD OF THE INVENTION

The present invention generally relates to fabrication of composite items. More particularly, the present invention pertains to fabricating a composite item having.

### BACKGROUND OF THE INVENTION

Composite materials have been used increasingly in a variety of industries, including the automotive, marine and aerospace industries. Composite materials have been used to produce lightly loaded structures, such as boat hulls or automobile body panels. Composite materials have also been applied in the manufacture of load-carrying or highly loaded structures, such as pressure vessels, frames, fittings, and aircraft fuselages.

Composite materials especially have application in the design of load bearing structural members. Composite materials used in these designs include strong fibrous materials, such as carbon, aramid, glass or quartz, bonded together with a resin material, such as an epoxy. Such materials can have the advantage of a high tensile strength to weight ratio, permitting the design of lightweight structures having substantial strength in tension. Since the load in these materials is carried primarily by the fibers, the load carrying properties of the material may be altered in response to the orientation of the fibers in the composite material. For example composite materials with unidirectional fibers (e.g., “tape”) are generally strongest in tension along the axis of the fibers but relatively weaker in the other directions. Woven fabrics and bi-directional mats are typically strongest in the plane of the material. Thus, when designing composite items, fiber orientation and the number of layers, also known as plies, is typically specified to coincide with anticipated load the composite item will experience. Layers and plies can also be broken down further into categories such as full plies, partial plies, localized doublers pliers and filler plies.

However, composite material designs can have the disadvantage that the unidirectional fibers and woven fibers of tape and fabric do not readily follow the contour of some, relatively curved or convoluted, structural members. For example, in a structural element that includes a surface that is curved within a plane, the composite material can be trimmed to the shape of the planar arc, but the fibers do not follow the curve of the arc. In addition, composite items molded in a matched die set typically require some flow of material in order to properly form the item. In this forming process, material flows from high pressure areas of the part to low pressure areas of the part. The pressure difference is caused when the ply stack does not exactly match the cross sectional cavity produced by the match die tool. In such a design, the tape or fabric may wrinkle or impede flow unacceptably. This condition is aggravated when the cross section of the part is not constant. Conventionally, thicker areas of the part require extensive tailoring of the layup or charge, applying localized layers, plies including skin plies, doublers plies and filler plies to compensate for the changing cross section. To overcome these issues, sheet molding composite materials have been developed with relatively short fibers that are substantially randomly oriented within the material. These sheet molding materials have relatively high molding flow characteristics as compared to fabric and tape and sufficient strength to weight ratio for many applications.

Unfortunately, items fabricated with conventional sheet molding materials exhibit unsatisfactory imaging and/or sound attenuating properties. That is, the unorganized configuration of the fiber causes sound and other wave forms to move through the item unevenly. Consequently, defects that are conventionally identified via ultrasonic inspection may be masked.

Accordingly, it is desirable to provide a composite item, apparatus and method for improving the inspectability of composite items that is capable of overcoming the disadvantages described herein at least to some extent.

### SUMMARY OF THE INVENTION

The foregoing needs are met, to a great extent, by the present invention, wherein in one respect a system, apparatus and method is provided that in some embodiments facilitates improving imaging characteristics of a composite item fabricated from a layup of composite material.

An embodiment of the present invention relates to a method of improving imaging characteristics of a composite item fabricated from a layup of composite material. In this method, layers of sheet molding materials are interleaved with layers of organized fiber structure prepreg to generate the layup and the layup is positioned in a mold cavity of a matched die form. In addition, a first form of the matched die form is urged towards a second form of the matched die form to facilitate flow of a portion of the layup from an area of excess composite material in the mold cavity to an area of insufficient composite material in the mold cavity and the layup is cured to generate the composite item.

Another embodiment of the present invention pertains to a method of fabricating a composite item with improved imaging properties from a layup of composite material. In this method, the layup is generated, the layup is molded layup to correspond to the composite item, and the layup is cured. To generate the layup, a layer of sheet molding material is positioned on a first form of a matched die form and a layer of organized fiber structure prepreg is positioned on the first form. To mold the layup, the first form is urged towards a second form of the matched die form to facilitate flow of a portion of the layup from a relatively thin region of the composite item to a relatively thick region of the composite item. The molded layup is cured to generate the composite item.

Yet another embodiment of the present invention relates to a system for fabricating a molded composite item with improved imaging characteristics. The system includes a form to mold a layup into the composite item, the form having a first portion and a second portion, a plurality of layers of sheet molding material, and a plurality of layers of organized fiber structure prepreg. The plurality of layers of sheet molding material are interleaved with the plurality of layers of organized fiber structure prepreg to generate a layup. The layup is sandwiched between the first portion and the second portion with sufficient compressive force facilitate flow of the layup from relatively thin regions of the item to relatively thick regions of the item.

Yet another embodiment of the present invention pertains to an apparatus for improving imaging characteristics of a composite item fabricated from a layup of composite material. The apparatus includes a means for interleaving layers of sheet molding materials with layers of organized fiber structure prepreg to generate the layup, means for positioning the layup in a mold cavity of a matched die form, and means for urging a first form of the matched die form towards a second form of the matched die form to facilitate flow of a portion of the layup from an area of excess composite material in the mold cavity to an area of insufficient composite material in the mold cavity. The apparatus further includes a means for curing the layup to generate the composite item.

Yet another embodiment of the present invention relates to an apparatus for fabricating a composite item from a layup of composite material. The apparatus includes a means for generating the layup, means for molding the layup to correspond to the composite item, and means for curing the molded layup. The means for generating the layup includes a means for positioning a layer of sheet molding material on a first form of a matched die form and means for positioning a layer of organized fiber structure prepreg on the first form. The means for molding the layup includes a means for urging the first form towards a second form of the matched die form to facilitate flow of a portion of the layup from a relatively thin region of the composite item to a relatively thick region of the composite item. The means for curing cures the molded layup to generate the composite item.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of a composite item fabrication system according to an embodiment of the invention.

FIG. 2 is a cross-sectional view of a form for molding the composite item suitable for use with the composite item fabrication system according to FIG. 1.

FIG. 3A is a plan view of an aircraft window frame suitable for fabrication with the composite item fabrication system according to FIG. 1.

FIG. 3B is a cross-sectional view of the aircraft window frame according to FIG. 3A.

FIG. 4A is a detailed view of an ultrasonic image of the aircraft window frame according to FIG. 3A.

FIG. 4B is a detailed view of an ultrasonic image of a conventionally fabricated composite item.

### DETAILED DESCRIPTION OF THE PREFERRED EMBODIMENT

The present invention provides a method, system, and apparatus for improving imaging characteristics of a composite item fabricated from a layup of composite material. In the method, layers of sheet molding materials are interleaved with layers of organized fiber structure prepreg to generate the layup and the layup is positioned in a mold cavity of a matched die form. In addition, a first form of the matched die form is urged towards a second form of the matched die form to facilitate flow of a portion of the layup from an area of excess composite material in the mold cavity to an area of insufficient composite material in the mold cavity and the layup is cured to generate the composite item. The system includes a form to mold a layup into the composite item, the form having a first portion and a second portion, a plurality of layers of sheet molding material, and a plurality of layers of organized fiber structure prepreg. The plurality of layers of sheet molding material are interleaved with the plurality of layers of organized fiber structure prepreg to generate a layup. The layup is sandwiched between the first portion and the second portion with sufficient compressive force facilitate flow of the layup from relatively thin regions of the item to relatively thick regions of the item. The apparatus includes a means for interleaving layers of sheet molding materials with layers of organized fiber structure prepreg to generate the layup, means for positioning the layup in a mold cavity of a matched die form, and means for urging a first form of the matched die form towards a second form of the matched die form to facilitate flow of a portion of the layup from an area of excess composite material in the mold cavity to an area of insufficient composite material in the mold cavity. The apparatus further includes a means for curing the layup to generate the composite item.

Composite materials such as, for example, fiber reinforced plastics (“FRP”) are widely utilized to increase structural rigidity in a wide variety of products. The fibers in the FRP may include any suitable fiber material bound in any suitable plastic or resin matrix and the fibers may be arranged in any suitable manner. Suitable examples of fiber material include, for example, a multitude of natural and/or “man-made” materials such as fiberglass, quartz, graphite, polyaramids, and the like. Suitable arrangements include, for example, unidirectional tape, bi-axial mats, tri-axial mats, woven fibers in a fabric, 2-dimensional and 3-dimensional diamond and flat braids, and/or a variety of other conformations. The fibers may be many yards (meters) or continuous and the FRPs are typically strongest in the direction of the fibers. A benefit of FRPs with relatively long fibers (“LFRPs”) or relatively organized fibers (e.g., tape, fabric, bi-axial and tri-axial cloth, braids, and the like) is that ultrasonic waves propagate therethrough sufficiently well to facilitate ultrasonic inspection of items fabricated therewith. This property may be especially beneficial in identifying internal flaws that may not be visible from the outside. One drawback of the organized fiber structure pre-impregnated LFRPs is that they typically do not flow or mold well and are therefore not recommended for matched die molding techniques. In particular, the fibers may not flow or slide past one another and may retard flow of resin into convoluted or tapered sections of some molds or forms.

FRPs may also include relatively short or “chopped” fiber mats. The fiber length in chopped fiber mats is generally less than 1 foot (0.3 meters) and may be less than 1 inch (2.54 centimeters). The fibers in chopped fiber mats are typically arranged essentially randomly. These relatively short, randomly arranged fibers allow for relatively high flow rates that are suitable for matched die molding. For this reason, chopped fiber mats that are pre-impregnated with resin are typically called “sheet molding” materials. Embodiments of the invention may include any suitable sheet molding material. Suitable sheet molding materials include resin impregnated reinforcement materials provided as rolls or sheets that exhibit suitable flow characteristics. A specific example of a suitable sheet molding material includes products manufactured by Hexcel composites of Pleasenton, Calif., 94588 U.S.A.

A disadvantage of sheet molding materials is that composite items fabricated with these materials do not image well due to flow and disorganization of fibers that attenuate more sound and less evenly than organized fiber structure prepregs such as from tape, fabric cloth, braids, and the like. That is, ultrasonic inspection of sheet molded items reveals a variety of artifacts that may mask internal defects. It is an advantage of embodiments of the invention that sheet molding materials may be utilized in conjunction with long-fiber FRPs to facilitate matched die fabrication of composite items that may be ultrasonically inspected.

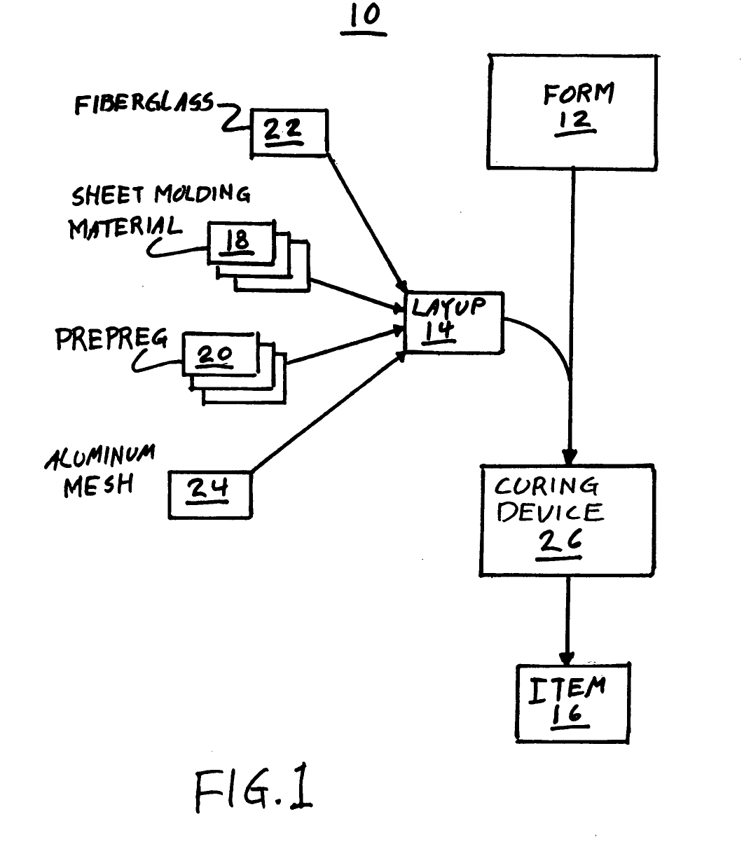

The invention will now be described with reference to the drawing figures, in which like reference numerals refer to like parts throughout. FIG. 1 is a block diagram of a composite item fabrication system 10 according to an embodiment of the invention. The system 10 includes a form 12 to mold a layup 14 into an item 16. The layup 14 includes a sheet molding material 18 and a relatively long fiber FRP material or organized fiber structure prepreg 20. The layup 14 optionally includes a fiberglass cloth 22 and an aluminum mesh 24. Depending upon the resin utilized, the system 10 optionally includes a curing device 26.

In general, the layup 14 according to various embodiments includes layers of the sheet material 18 interleaved with layers of the organized fiber structure prepreg 20. For example, a layer of the sheet material 18 may be positioned in or on the form 12 and then a layer of the organized fiber structure prepreg 20 may be positioned upon the layer of the sheet material 18. This alternating pattern may continue until an adequate thickness or weight of material is placed in or on the form 12. In another example, one, two or more layers of sheet material 18 may be positioned in or on the form 12 and then one, two, or more layers of the organized fiber structure prepreg 20 may be positioned upon the layer(s) of the sheet material 18. That is, any suitable interleaving pattern of the sheet material 18 and organized fiber structure prepreg 20 may be utilized to generate the layup 14. The suitability of the interleaving pattern may depend upon a variety of factors such as, for example, weight and/or thickness of the item 16, weight and/or thickness of the sheet molding material 18 and/or the organized fiber structure prepreg 20, inspection protocol for the item 16, load performance characteristics of the item 16, desired surface appearance, empirical data, manufactures recommendations, and the like.

The fiberglass cloth 22 and an aluminum mesh 24 are optionally included depending upon the purpose of the item 16. For example, the fiberglass cloth 22 may be included to thermally and/or electrically insulate the item 16 or reduce galvanic effects upon the item 16. In addition, the fiberglass cloth 22 may improve surface appearance and may reduce drill breakout during boring operations. The aluminum mesh 24 may include any electrically conductive material and may help dissipate static or lightning related electrical charges.

An embodiment may include a hand, or manual, layup process, or an automated layup process, wherein a composite material, such as the sheet molding material 18 and/or the organized fiber structure prepreg 20, is placed on a form, mandrel, or manufacturing tool. In addition, these and other embodiments may include various techniques such as, for example, debulking, compaction, degassing, and the like.

If present, the curing device 26 includes any suitable device or protocol to cure the resin present in one or more of the sheet molding material 18, the organized fiber structure prepreg 20, and the fiberglass cloth 22. Suitable examples of curing devices include hot oil baths, autoclaves, ovens, heating rods placed in or around the form 12, radiation emitters that emit microwave, infrared, e-beam, and/or other forms of radiation suitable for curing the resin.

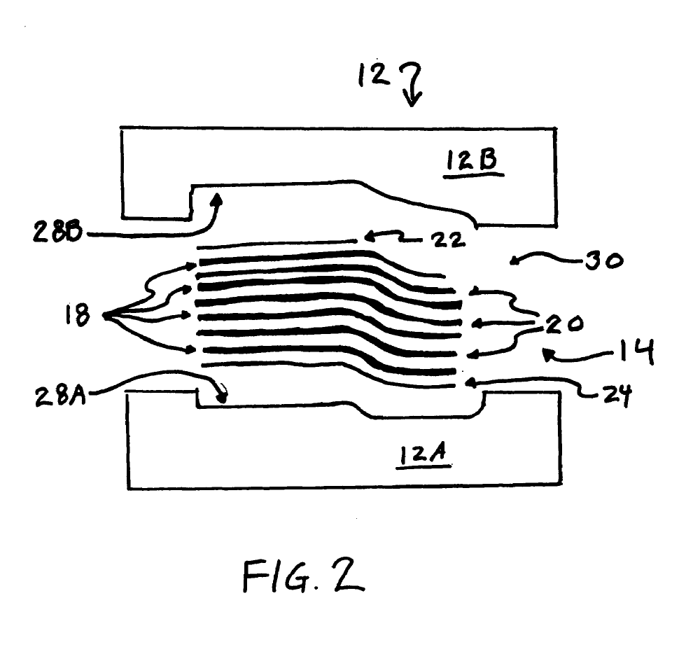

FIG. 2 is a cross-sectional view of the form 12 for molding the item 16 suitable for use with the composite item fabrication system 10 according to FIG. 1. As shown in FIG. 2, the form 12 includes a lower portion or lower form 12a and an upper portion or upper form 12b. The lower form 12a and the upper portion or upper form 12b may be described as a matched die set. The lower form 12a includes a lower form surface 28a and the upper form 12b includes an upper form surface 28b. When mated together, the lower form surface 28a and upper form surface 28b generate a mold cavity 30 to form the item 16. In the particular example shown, the mold cavity 30 corresponds to a window frame of an aircraft.

Each of the lower form surface 28a and upper form surface 28b may be configured to be compatible with the composite system utilized. For example, the surfaces may be relatively smooth and coated with a release agent to facilitate removal of the item 16 from the form 12. The form 12 and surfaces 28a and 28b may also be compatible with the method of curing. More particularly, the form 12 and surfaces 28a and 28b may be heat, pressure, and/or radiation resistant as appropriate for the resin system.

In the particular example shown, the layers of the layup 14 are, from bottom to top, the aluminum mesh 24, alternating layers of the sheet molding material 18 and the organized fiber structure prepreg 20, and the fiberglass cloth 22. It is to be noted that the number of layers shown is purely for illustrative purposes. In particular, the layers of the sheet molding material 18 and the organized fiber structure prepreg 20 may include any suitable number of plies such as two to tens or hundreds or more layers in order to achieve sufficient weight and/or thickness of the layup 14.

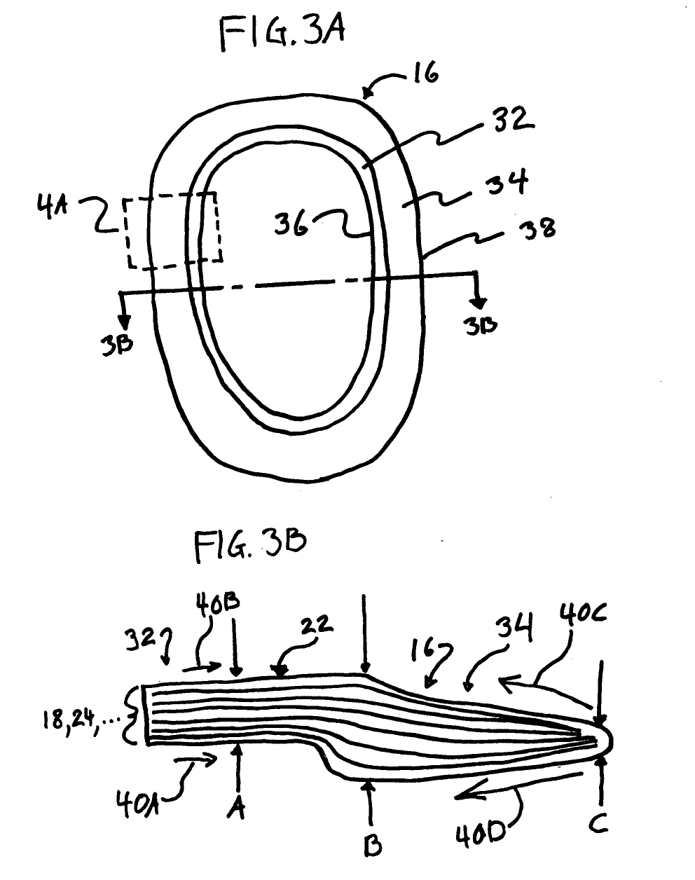

FIG. 3A is a plan view of an aircraft window frame suitable for fabrication with the composite item fabrication system 10 according to FIG. 1. As shown in FIG. 3A, the item 16 or aircraft window frame is generally ovoid in shape and includes an inner flange 32, outer flange 34, inner flange edge 36, and outer flange edge 38. The inner flange 32 and inner flange edge 36 are configured to retain a window transparency with appropriate fasteners and/or seals. The outer flange 34 and outer flange edge 38 are configured to affix the item 16 to an aircraft fuselage assembly.

Of note, although the item 16 is shown as an aircraft window frame in the FIG. 3A, embodiments of the invention are not limited to aircraft window frames, but rather, any suitable item or component may be fabricated according to embodiments of the invention. Suitable items include, for example: other aircraft components such as panels, frames, spars, C-channels, I-channels, Z-channels; fittings; automotive and marine components such as body panels and structural members; sporting equipment; and the like.

Additionally, although the use of FRP composites are particularly described herein, it is within the scope of the invention that metal foil composites and/or films may be utilized in embodiments. In a specific example, resin impregnated Titanium graphite (“TiGr”) layers may be substituted for some or all of the layers of organized fiber structure prepreg 20.

FIG. 3B is a cross-sectional view of the aircraft window frame according to FIG. 3A. As shown in FIG. 3B, the item 16 includes regions of varying thicknesses. For illustrative purposes, three generalized areas are identified, namely region A, B, and C that roughly correspond to the inner flange 32, a transition from inner flange to outer flange, and outer flange 34, respectively. Also shown in FIG. 3B are arrows 40a-40d that roughly indicate flow direction and magnitude during fabrication of the item 16. That is, the layup 14 may be generated with a substantially even thickness throughout. During fabrication of the item 16, pressure may be applied to the form 12 urging the upper and lower forms 12a and 12b together and/or heat may be applied to the form 12 and/or the layup 14 to decrease the viscosity of the resin. As a result of these conditions, a volume of the layup 14 may flow as indicated by the arrows 40a-40d. More particularly, a relatively larger layup volume is shown flowing from the region C (outer flange 34) towards region B as compared to a relatively smaller layup volume flowing from the region A (inner flange 32) towards the region B.

In this manner, a volume of the layup 14 may flow from an area of excess composite material (e.g., regions A and C) to an area of insufficient composite material (e.g., region B). It is an advantage of embodiments of the invention that internal and/or external voids or other flaws may be reduced by the relatively high flow properties of the layup 14. These flow properties may be achieved while maintaining acceptable imaging properties of the item 16. In addition, it is an advantage of embodiments that “local doubling” and other labor intensive procedures to generate a layup that more closely approximates the final conformation of the item 16 may be avoided. As such, items fabricated in accordance with embodiments of the invention may be produced more easily and/or more quickly as compared to conventional composite items.

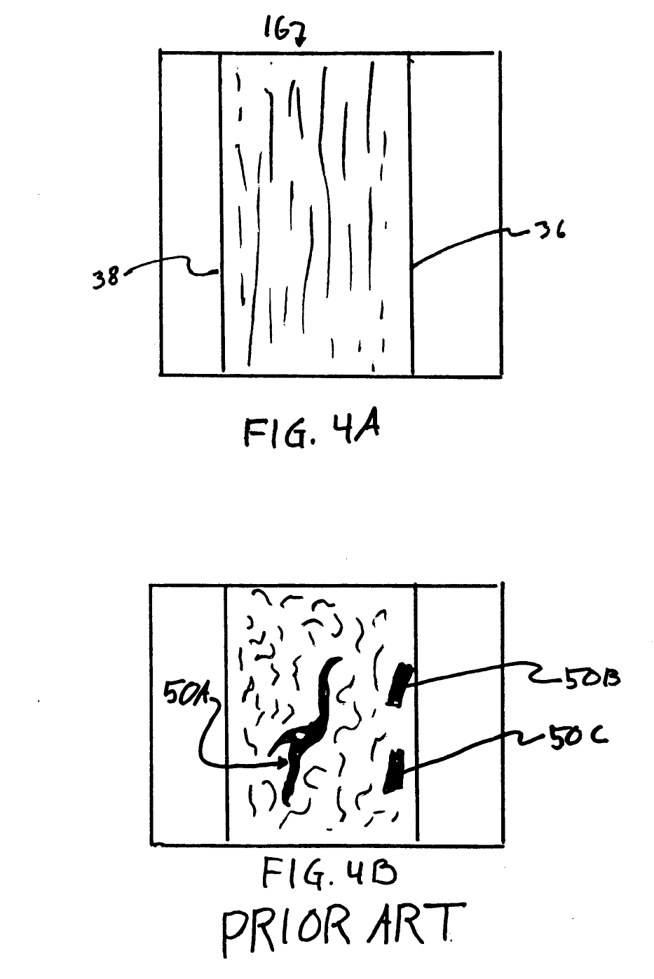

FIG. 4A is a detailed view of an ultrasonic image of the aircraft window frame according to FIG. 3A. As shown in FIG. 4A, the ultrasonic image is essentially uniform in appearance and substantially devoid of artifacts that may mask flaws. It is an advantage of embodiments that composite items such as the item 16 may be “tuned” for compatibility with varying imaging techniques. For example, greater or lesser amounts of LFRP may be utilized to fabricate the item 16 depending upon the imaging technique being utilized to inspect the item 16 and the size of a potential defect that may be identified or located. In addition, by altering the fiber arrangement (e.g., tape, bi-axial fabric, woven fabric, braids, etc.), the wave propagation or transmission properties of the item 16 tuned to function advantageously with the intended imaging technique.

FIG. 4B is a detailed view of an ultrasonic image of a conventionally fabricated composite item. As shown in FIG. 4B, the conventionally fabricated item includes artifacts 50a-50c. The artifacts 50a-50c increase the difficulty in inspecting the item for flaws. These and other types of artifacts are prevalent in items fabricated with sheet molding materials as the primary constituent. In general, the artifacts 50a-50c may be caused by the chopped fibers of the sheet molding material clumping or forming tangles, folds, wrinkles, resin pockets or other such structures that transmit wave forms differently that surrounding areas. These fiber structures reveal themselves during imaging. Depending on the imaging technique, the image may appear relatively darker or brighter using a gray tone image or in different colors when a color image is used. Other imaging techniques may utilize a real time screen that provides images of sound waves.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A method of fabricating a composite item from a layup of composite material, the method comprising:
interleaving layers of sheet molding materials with layers of organized fiber structure prepreg to generate the layup, the sheet molding materials comprising chopped fiber mats pre-impregnated with resin;
selecting an intended imaging technique for inspecting the composite item for defects;
selecting one of greater and lesser amounts of organized fiber structure prepreg in relation to the amount of sheet molding materials based upon at least one of the following:
a desired size of a defect to be detected in the composite item;
the intended imaging technique;
positioning the layup in a mold cavity of a matched die form;
urging a first form of the matched die form towards a second form of the matched die form to facilitate flow of a portion of the layup from an area of excess composite material in the mold cavity to an area of insufficient composite material in the mold cavity; and
curing the layup to generate the composite item.

2. The method according to claim 1, further comprising:
positioning a layer of conductive mesh on the layup.

3. The method according to claim 1, further comprising:
positioning a layer of woven fiberglass on the layup.

4. The method according to claim 1, further comprising:
debulking the layup.

5. The method according to claim 1, wherein curing further comprises:
heating the layup.

6. The method according to claim 1, further comprising:
positioning a localized partial doubler ply in the mold cavity, wherein the localized partial doubler ply reduces an amount of flow from relatively thin regions of the layup to relatively thick regions of the layup creating a cross section that more closely represents the mold cavity.

7. The method according to claim 1, further comprising:
positioning a filler ply in the mold cavity, wherein the filler ply reduces an amount of flow from relatively thin regions of the layup to relatively thick regions of the layup creating a cross section that more closely represents the mold cavity.

8. A method of fabricating a composite item with improved imaging properties from a layup of composite material, the method comprising:
generating the layup, the generating comprising:
interleaving a plurality of layers of sheet molding material and a plurality of layers of organized fiber structure prepreg on a first form of a matched die form, the sheet molding materials comprising chopped fiber mats pre-impregnated with resin;
selecting an intended imaging technique for inspecting the composite item for defects; and
selecting one of greater and lesser amounts of organized fiber structure prepreg in relation to the amount of sheet molding materials based upon at least one of the following:
a desired size of a defect to be detected in the composite item;
the intended imaging technique;
molding the layup to correspond to the composite item, the molding comprising:
urging the first form towards a second form of the matched die form; and
curing the molded layup to generate the composite item.

9. (canceled)

10. The method according to claim 8, further comprising:
positioning a layer of conductive mesh on the layup.

11. The method according to claim 8, further comprising:
positioning a layer of woven fiberglass on the layup.

12. The method according to claim 8, further comprising:
debulking the layup.

13. The method according to claim 8, wherein curing further comprises:
heating the layup.

14. The method according to claim 8, further comprising:
positioning a localized partial doubler ply on the first form, wherein the localized partial doubler ply reduces an amount of flow from relatively thin regions of the layup to relatively thick regions of the layup creating a cross section that more closely represents a mold cavity defined by the matched die form.

15. The method according to claim 8, further comprising:
positioning a filler ply on the first form, wherein the filler ply reduces an amount of flow from relatively thin regions of the layup to relatively thick regions of the layup creating a cross section that more closely represents a mold cavity defined by the matched die form.

16. A system for fabricating a molded composite item with improved imaging characteristics, the system comprising:
a form to mold a layup into the composite item, the form having a first portion and a second portion;
a plurality of layers of sheet molding material; and
a plurality of layers of organized fiber structure prepreg, wherein the plurality of layers of sheet molding material are interleaved with the plurality of layers of organized fiber structure prepreg to generate a layup and wherein the layup is sandwiched between the first portion and the second portion with sufficient compressive force facilitate flow of the layup from relatively thin regions of the item to relatively thick regions of the item.

17. The system according to claim 16, further comprising:
a layer of fiberglass to provide a corrosion barrier for the composite item.

18. The system according to claim 16, further comprising:
a layer of conductive mesh to provide a lightning strike barrier for the composite item.

19. The system according to claim 16, further comprising:
a curing device to cure the composite item.

20. The system according to claim 16, further comprising:
a roller to debulk the composite item.

21. An apparatus for improving imaging characteristics of a composite item fabricated from a layup of composite material, the apparatus comprising:
means for interleaving layers of sheet molding materials with layers of organized fiber structure prepreg to generate the layup;
means for positioning the layup in a mold cavity of a matched die form;
means for urging a first form of the matched die form towards a second form of the matched die form to facilitate flow of a portion of the layup from an area of excess composite material in the mold cavity to an area of insufficient composite material in the mold cavity; and
means for curing the layup to generate the composite item.

22. The apparatus according to claim 21, further comprising:
means for positioning a layer of conductive mesh on the layup.

23. The apparatus according to claim 21, further comprising:
means for positioning a layer of woven fiberglass on the layup.

24. The apparatus according to claim 21, further comprising:
means for debulking the layup.

25. The apparatus according to claim 21, wherein curing further comprises:
means for heating the layup.

26. The apparatus according to claim 21, further comprising:
means for positioning a localized partial doubler ply in the mold cavity, wherein the localized partial doubler ply reduces an amount of flow from relatively thin regions of the layup to relatively thick regions of the layup creating a cross section that more closely represents the mold cavity.

27. The apparatus according to claim 21, further comprising:
means for positioning a filler ply in the mold cavity, wherein the filler ply reduces an amount of flow from relatively thin regions of the layup to relatively thick regions of the layup creating a cross section that more closely represents the mold cavity.

28. An apparatus for fabricating a composite item from a layup of composite material, the apparatus comprising:
means for generating the layup, the generating comprising:
means for positioning a layer of sheet molding material on a first form of a matched die form; and
means for positioning a layer of organized fiber structure prepreg on the first form;
means for molding the layup to correspond to the composite item, the molding comprising:
means for urging the first form towards a second form of the matched die form; and
means for curing the molded layup to generate the composite item.

29. The apparatus according to claim 28, further comprising:
means for positioning a multitude of layers of sheet molding material and organized fiber structure prepreg on the first form, wherein the layers of sheet molding material are interleaved between the layers of organized fiber structure prepreg and wherein the composite item is substantially free from imaging artifacts.

30. The apparatus according to claim 28, further comprising:
means for positioning a layer of conductive mesh on the layup.

31. The apparatus according to claim 28, further comprising:
means for positioning a layer of woven fiberglass on the layup.

32. The apparatus according to claim 28, further comprising:
means for debulking the layup.

33. The apparatus according to claim 28, wherein curing further comprises:
means for heating the layup.

34. The apparatus according to claim 28, further comprising:
means for positioning a localized partial doubler ply on the first form, wherein the localized partial doubler ply reduces an amount of flow from relatively thin regions of the layup to relatively thick regions of the layup creating a cross section that more closely represents a mold cavity defined by the matched die form.

35. The apparatus according to claim 28, further comprising:
means for positioning a filler ply on the first form, wherein the filler ply reduces an amount of flow from relatively thin regions of the layup to relatively thick regions of the layup creating a cross section that more closely represents a mold cavity defined by the matched die form.

36. The method according to claim 1, wherein:
the organized fiber structure prepreg is a long fiber reinforced plastic.

37. The method according to claim 8, wherein:
the organized fiber structure prepreg is a long fiber reinforced plastic.

38. The method according to claim 1, further comprising the step of:
selecting a desired wave transmission property of the composite item; and
selecting a fiber arrangement of the organized fiber structure prepreg based upon the intended imaging technique to provide the desired wave transmission property.

39. The method according to claim 38 wherein the step of selecting the fiber arrangement of the organized fiber structure prepreg comprises:
selecting from at least one of the following configurations of the organized fiber structure prepreg: unidirectional tape, bi-axial mat, woven fabric, braided material.

40. The method according to claim 8, further comprising the step of:
selecting a desired wave transmission property of the composite item; and
selecting a fiber arrangement of the organized fiber structure prepreg based upon the intended imaging technique to provide the desired wave transmission property.

41. The method according to claim 40 wherein the step of selecting the fiber arrangement of the organized fiber structure prepreg comprises:
selecting from at least one of the following configurations of the organized fiber structure prepreg: unidirectional tape, bi-axial mat, woven fabric, braided material.

42. The method according to claim 1, wherein:
the chopped fiber mats are comprised of fiber having a length of at least approximately 1 inch.

43. The method according to claim 8, wherein:
the chopped fiber mats are comprised of fiber having a length of at least approximately 1 inch.
